(19) United States
(12) Patent Application Publication
(10) Pub. No.: US 2026/0146965 A1
(43) Pub. Date: May 28, 2026

(54) SENSOR

(71) Applicant: KABUSHIKI KAISHA TOSHIBA, Tokyo (JP)

(72) Inventors: Yumi HAYASHI, Ayase Kanagawa (JP); Ko YAMADA, Yokohama Kanagawa (JP)

(73) Assignee: KABUSHIKI KAISHA TOSHIBA, Tokyo (JP)

(21) Appl. No.: 19/257,624

(22) Filed: Jul. 2, 2025

(30) Foreign Application Priority Data
Nov. 25, 2024 (JP) 2024-204949

(51) Int. Cl. G01N 27/12; G01N 27/22

(52) U.S. Cl. CPC G01N 27/12; G01N 27/227

(57) ABSTRACT

According to one embodiment, a sensor includes a first element portion. The first element portion includes an element member, a first electrode including a first side portion, a second electrode including a second side portion, and an oxide member including a first oxide portion. The element member includes a first element layer, a first protruding portion provided on the first element layer and protruding in a first direction, and a second protruding portion provided on the first element layer and protruding in the first direction. A second direction from the first protruding portion to the second protruding portion crosses the first direction. The first oxide portion is between the first protruding portion and the second protruding portion. The first side portion is between the first protruding portion and the first oxide portion. The second side portion is between the first oxide portion and the second protruding portion.

### CROSS-REFERENCE TO RELATED APPLICATIONS

This application is based upon and claims the benefit of priority from Japanese Patent Application No.2024-204949, filed on Nov. 25, 2024; the entire contents of which are incorporated herein by reference.

### FIELD

Embodiments described herein relate generally to a sensor.

### BACKGROUND

For example, there is a sensor for detecting a detection target such as gas, etc. It is desirable to improve the characteristics of the sensor.

### BRIEF DESCRIPTION OF THE DRAWINGS

FIGS. 1A and 1B are schematic cross-sectional views illustrating a sensor according to a first embodiment;

FIG. 2 is a schematic plan view illustrating the sensor according to the first embodiment;

FIG. 3 is a schematic cross-sectional view illustrating a part of the sensor according to the first embodiment;

FIG. 4 is a schematic cross-sectional view illustrating a sensor according to a second embodiment;

FIG. 5 is a schematic cross-sectional view illustrating a sensor according to the second embodiment; and

FIG. 6 is a schematic cross-sectional view illustrating a sensor according to the second embodiment.

### DETAILED DESCRIPTION

According to one embodiment, a sensor includes a first element portion. The first element portion includes an element member, a first electrode including a first side portion, a second electrode including a second side portion, and an oxide member including a first oxide portion. The element member includes a first element layer, a first protruding portion provided on the first element layer and protruding in a first direction, and a second protruding portion provided on the first element layer and protruding in the first direction. A second direction from the first protruding portion to the second protruding portion crosses the first direction. The first oxide portion is between the first protruding portion and the second protruding portion. The first side portion is between the first protruding portion and the first oxide portion. The second side portion is between the first oxide portion and the second protruding portion.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

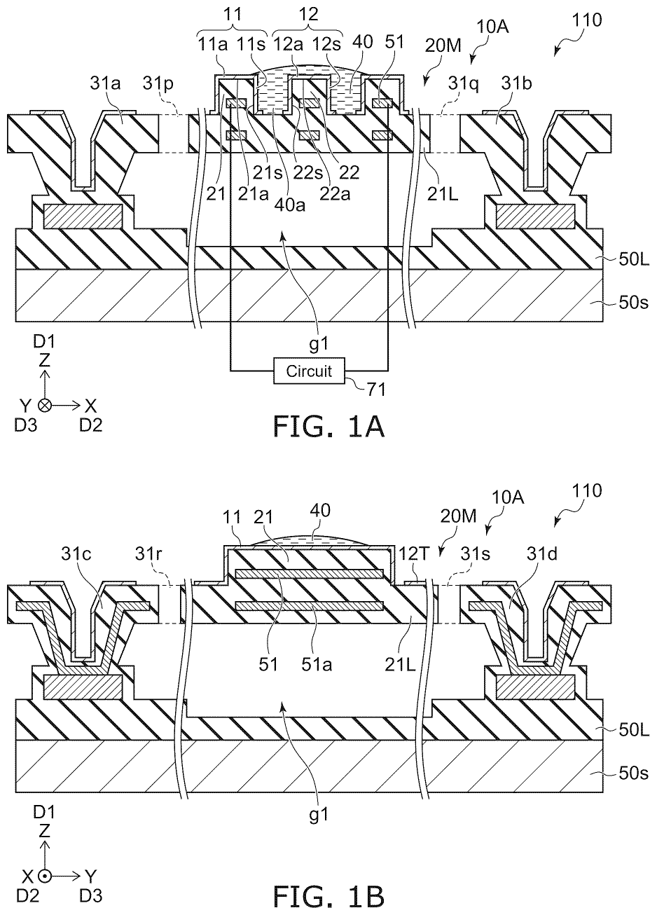

FIGS. 1A and 1B are schematic cross-sectional views illustrating the sensor according to the first embodiment.

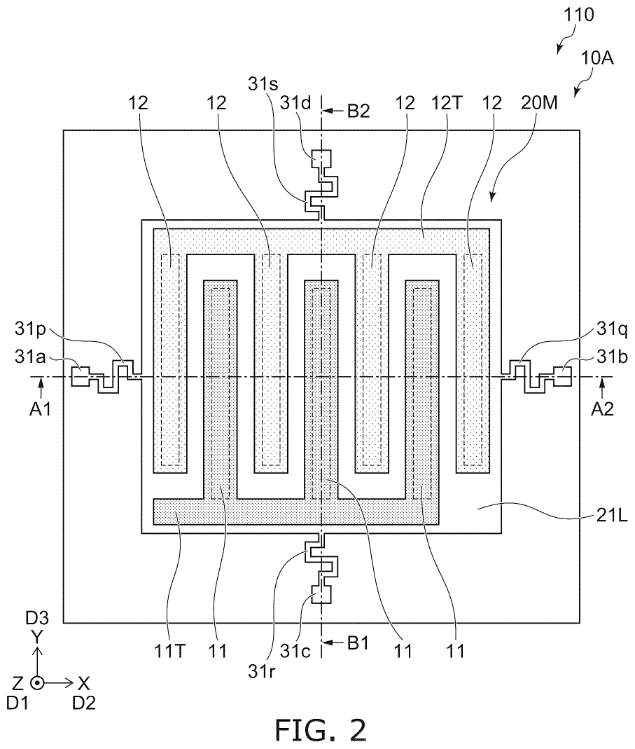

FIG. 2 is a schematic plan view illustrating the sensor according to the first embodiment.

FIG. 1A corresponds to a cross-sectional view taken along the line A1-A2 in FIG. 2. FIG. 1B corresponds to a cross-sectional view taken along the line B1-B2 in FIG. 2.

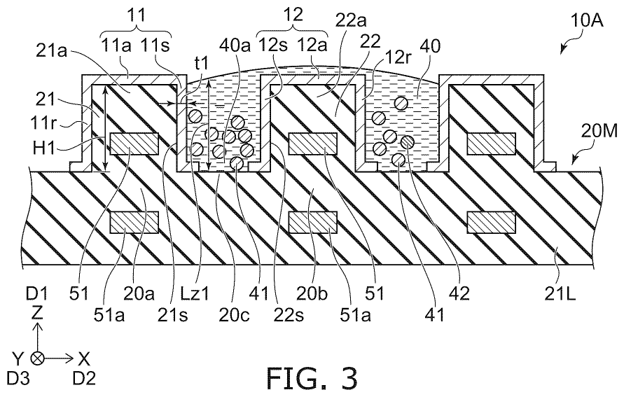

FIG. 3 is a schematic cross-sectional view illustrating a part of the sensor according to the first embodiment.

As shown in FIGS. 1A, 1B, and 2, a sensor 110 according to the embodiment includes a first element portion 10A.

The first element portion 10A includes an element member 20M, a first electrode 11, a second electrode 12, and an oxide member 40. The first electrode 11 includes a first side portion 11s. The second electrode 12 includes a second side portion 12s. The oxide member 40 includes a first oxide portion 40a.

The element member 20M includes a first element layer 21L, a first protruding portion 21, and a second protruding portion 22. The first protruding portion 21 is provided on the first element layer 21L and protrudes in a first direction D1. The second protruding portion 22 is provided on the first element layer 21L and protrudes in the first direction D1.

The first direction D1 is defined as a Z-axis direction. One direction perpendicular to the Z-axis direction is defined as a X-axis direction. A direction perpendicular to the Z-axis direction and the X-axis direction is defined as a Y-axis direction.

The first element layer 21L is along the X-Y plane. The first element layer 21L is, for example, layer-like. The first element layer 21L is, for example, membrane-like. The first element layer 21L is, for example, insulating.

A second direction D2 from the first protruding portion 21 to the second protruding portion 22 crosses the first direction D1. The second direction D2 is, for example, the X-axis direction.

The first oxide portion 40a is located between the first protruding portion 21 and the second protruding portion 22. The first side portion 11s is located between the first protruding portion 21 and the first oxide portion 40a. The second side portion 12s is located between the first oxide portion 40a and the second protruding portion 22.

In the sensor 110, the first electrode 11 and the second electrode 12 are configured such that the electrical resistance between the first electrode 11 and the second electrode 12 changes in response to a first detection target around the first element portion 10A.

In the sensor 110, the first electrode 11 is spatially separated from the second electrode 12. The oxide member 40 is provided in at least a part of a region between the first electrode 11 and the second electrode 12. The characteristics of the oxide included in the oxide member 40 change in response to the first detection target present around the first element portion 10A. In response to the change in the oxide characteristics, the electrical resistance between the first electrode 11 and the second electrode 12 changes in response to the first detection target. The first detection target can be detected by detecting the change in electrical resistance. The first detection target is, for example, a gas or liquid. The first detection target may include, for example, hydrogen. The sensor 110 may be, for example, a gas sensor.

In the sensor 110, an electrode is provided on each side of the two protruding portions. The two electrodes can face each other over a wide area in the second direction D2. As a result, the electrical resistance between the two electrodes changes with high sensitivity to changes in the characteristics of the oxide member 40 that correspond to changes in the first detection target. According to the embodiment, a sensor with improved characteristics can be provided.

For example, a reference example can be considered in which two electrode layers are provided on a flat element layer. In this case, the oxide member 40 is provided between the side faces of the two electrode layers. If the two electrode layers are thin, it is difficult to obtain high sensitivity because the amount of the oxide member 40 located between the two electrode layers is small. On the other hand, if the two electrode layers are thick, it becomes difficult to form and process the electrode layers, and costs increase.

In the embodiment, an electrode layer is provided on each side of the plurality of protruding portions. The electrode layer may be thin. In the embodiment, the electrode layer is easy to form and process, while high sensitivity is obtained.

As shown in FIG. 3, the first protruding portion 21 includes a first side face 21s that crosses the second direction D2. The second protruding portion 22 includes a second side face 22s that crosses the second direction D2. The first side portion 11s is provided on the first side face 21s. The second side portion 12s is provided on the second side face 22s.

As shown in FIG. 3, the first protruding portion 21 may further include a first apex region 21a. The second protruding portion 22 may further include a second apex region 22a. The first electrode 11 may further include a first apex portion 11a provided on the first apex region 21a. The second electrode 12 may further include a second apex portion 12a provided on the second apex region 22a.

As shown in FIG. 3, the first electrode 11 may further include a first other side portion 11r. The second electrode 12 may further include a second other side portion 12r. At least a part of the first protruding portion 21 may be provided between the first other side portion 11r and the first side portion 11s in the second direction D2. At least a part of the second protruding portion 22 may be provided between the second side portion 12s and the second other side portion 12r in the second direction D2.

As shown in FIG. 3, the first element layer 21L may include a first non-overlapping region 20c. The first non-overlapping region 20c does not overlap the first protruding portion 21 in the first direction D1. The first non-overlapping region 20c does not overlap the second protruding portion 22 in the first direction D1. A direction from a part of the first non-overlapping region 20c to a part of the first electrode 11 may be along the first direction D1. A part of the first electrode 11 may be provided on the first non-overlapping region 20c.

The first element layer 21L may include a first overlap region 20a and a second overlap region 20b. The first overlap region 20a overlaps the first protruding portion 21 in the first direction D1. The second overlap region 20b overlaps the second protruding portion 22 in the first direction D1. The first non-overlapping region 20c is provided between the first overlap region 20a and the second overlap region 20b.

As shown in FIG. 3, a first height H1 of the first protruding portion 21 is more than a first thickness t1 of the first side portion 11s along the second direction D2. By sufficiently high first protruding portion 21, the first side portion 11s with a large area can be obtained. High sensitivity is easily obtained.

The first height H1 may be, for example, 5 times or more the first thickness t1. High sensitivity is obtained. The first height H1 may be, for example, 20 times or less the first thickness t1. The first element portion 10A being practical is obtained.

The first thickness t1 corresponds to the thickness of the first electrode 11. The first thickness t1 may be, for example, not less than 1 nm and not more than 200 nm. The first height H1 may be, for example, not less than 10 nm or more and not more than 1 μm.

As shown in FIG. 3, a length of the first side portion 11s along the first direction D1 is defined as a first side portion length Lz1. The first side portion length Lz1 is longer than the first thickness t1.

As shown in FIG. 3, the oxide member 40 includes a plurality of first particles 41. The plurality of first particles 41 includes an oxide. The oxide includes oxygen and at least one selected from the group consisting of tin, zinc, tungsten, molybdenum, and indium. An average diameter of the plurality of first particles 41 may be, for example, not less than 10 nm and not more than 500 nm.

The oxide member 40 may include a plurality of second particles 42. The plurality of second particles 42 may include, for example, at least one selected from the group consisting of platinum, gold, silver, copper, palladium, aluminum, and titanium nitride. By providing the plurality of second particles 42, for example, high sensitivity is easily obtained. The plurality of second particles 42 may function, for example, as a catalyst. The oxide member 40 may include a resin. The resin may be, for example, a polymer.

At least one of the first electrode 11 or the second electrode 12 may include at least one selected from the group consisting of platinum, gold, silver, copper, palladium, aluminum, and titanium nitride. For example, the surface portions of these electrodes may include at least one selected from the group consisting of platinum, gold, silver, copper, palladium, aluminum, and titanium nitride. These materials may function as, for example, a catalyst. The region including these materials may be in contact with the oxide member 40. High sensitivity is likely to be obtained.

As shown in FIG. 3, the element member 20M may further include a first conductive layer 51. At least a part of the first conductive layer 51 is located between a part of the first protruding portion 21 and another part of the first protruding portion 21 in the second direction D2. The first conductive layer 51 is embedded in the first protruding portion 21. For example, an insulating film may be formed to cover the first conductive layer 51, and this insulating film may become the first protruding portion 21.

Another part of the first conductive layer 51 may be provided between a part of the second protruding portion 22 and another part of the second protruding portion 22 in the second direction D2. The other part of the first conductive layer 51 is buried in the second protruding portion 22. For example, an insulating film may be formed so as to cover the other part of the first conductive layer 51, and this insulating film may become the second protruding portion 22. The first conductive layer 51 may have a meandering shape in the X-Y plane.

The element member 20M may further include a first other conductive layer 51a. At least a part of the first other conductive layer 51a may overlap the first conductive layer 51 in the first direction D1. The first other conductive layer 51a may have a meandering shape in the X-Y plane.

As shown in FIG. 1, the sensor 110 may further include a first circuit 71. The first circuit 71 may be configured to supply power to the first conductive layer 51. For example, the first conductive layer 51 may function as a heater. The first circuit 71 may be configured to supply power to the first other conductive layer 51a. Heat from the first conductive layer 51 is efficiently transferred to the oxide member 40. Higher sensitivity detection is possible.

As shown in FIG. 2, the first electrode 11 may extend along a third direction D3. The second electrode 12 may extend along the third direction D3. The third direction D3 crosses a plane including the first direction D1 and the second direction D2. The third direction D3 is, for example, the Y-axis direction.

The first element portion 10A may include a plurality of first electrodes 11 and a plurality of second electrodes 12. One of the plurality of first electrodes 11 is located between one of the plurality of second electrodes 12 and another one of the plurality of second electrodes 12. One of the plurality of second electrodes 12 is located between one of the plurality of first electrodes 11 and another one of the plurality of first electrodes 11. The first electrodes 11 and the second electrodes 12 may be provided alternately. A first electrode connecting portion 11T may be provided to electrically connect the plurality of first electrodes 11. A second electrode connecting portion 12T may be provided to electrically connect the plurality of second electrodes 12. The plurality of first electrodes 11 and the plurality of second electrodes 12 may form a comb-tooth electrode.

The first protruding portion 21 is provided corresponding to each of the plurality of first electrodes 11. The second protruding portion 22 is provided corresponding to each of the plurality of second electrodes 12.

As shown in FIG. 1, the sensor 110 further includes a base 50s. The first element portion 10A further includes a first fixed portion 31a. The first fixed portion 31a is fixed to the base 50s. The first element layer 21L is supported by the first fixed portion 31a. A first gap g1 is provided between the base 50s and the first element layer 21L. The first element portion 10A has, for example, a MEMS (Micro Electro Mechanical Systems) structure.

As shown in FIG. 2, the first element portion 10A may further include a second fixed portion 31b, a third fixed portion 31c, and a fourth fixed portion 31d in addition to the first fixed portion 31a. These fixed portions are fixed to the base 50s. In the example of FIG. 2, a direction from the first fixed portion 31a to the second fixed portion 31b is along the second direction D2. In the example of FIG. 2, a direction from the third fixed portion 31c to the fourth fixed portion 31d is along the third direction D3. The first element layer 21L is supported by these fixed portions.

As shown in FIG. 2, the first element portion 10A may further include a first connecting portion 31p, a second connecting portion 31q, a third connecting portion 31r, and a fourth connecting portion 31s. The first connecting portion 31p is supported by the first fixed portion 31a and supports the first element layer 21L. The second connecting portion 31q is supported by the second fixed portion 31b and supports the first element layer 21L. The third connecting portion 31r is supported by the third fixed portion 31c and supports the first element layer 21L. The fourth connecting portion 31s is supported by the fourth fixed portion 31d and supports the first element layer 21L. These connecting portions may have a meandering structure.

### Second Embodiment

A sensor according to the second embodiment includes plurality of element portions.

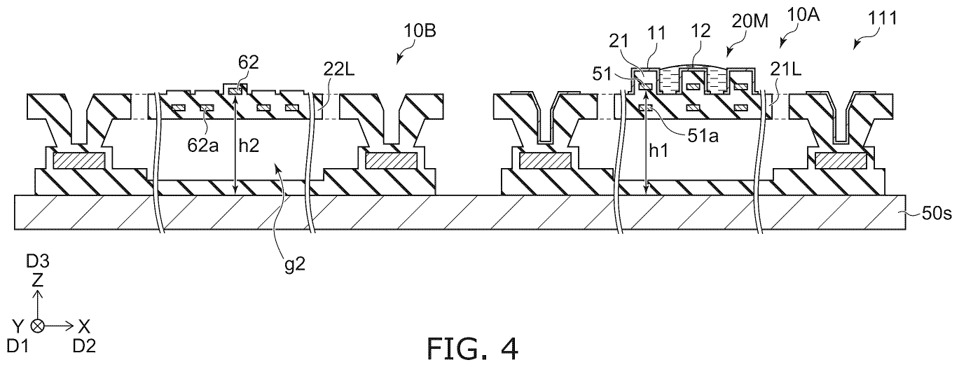

FIG. 4 is a schematic cross-sectional view illustrating a sensor according to the second embodiment.

As shown in FIG. 4, a sensor 111 according to the embodiment includes a second element portion 10B in addition to the first element portion 10A.

The second element portion 10B includes a second element layer 22L and a second conductive layer 62 fixed to the second element layer 22L. A second gap g2 is provided between the base 50s and the second element layer 22L. For example, the electrical resistance of the second conductive layer 62 changes depending on the flow speed of a second detection target around the second element portion 10B. A first conductive layer height h1 of the first conductive layer 51 with respect to the base 50s is substantially the same as a second conductive layer height h2 of the second conductive layer 62 with respect to the base 50s.

For example, the first conductive layer 51 may be formed from a material that will become the second conductive layer 62. A protruding portion (such as the first protruding portion 21) can be obtained by a simple process.

The second element portion 10B may further include a second other conductive layer 62a. The second conductive layer 62 is fixed to the second element layer 22L. Power may be supplied to the second other conductive layer 62a. The second other conductive layer 62a may function as a heater. The first other conductive layer 51a may be formed from a material that will become the second other conductive layer 62a.

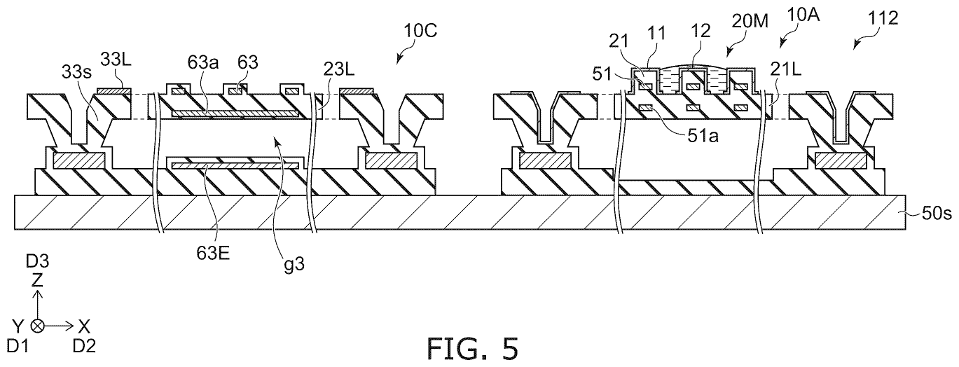

FIG. 5 is a schematic cross-sectional view illustrating a sensor according to the second embodiment.

As shown in FIG. 5, a sensor 112 according to the embodiment includes a third element portion 10C in addition to the first element portion 10A.

The third element portion 10C includes a fixed electrode 63E, a third element layer 23L, a third element support portion 33s, a third conductive layer 63, and a third other conductive layer 63a. The fixed electrode 63E is fixed to the base 50s. The third element support portion 33s is fixed to the base 50s and supports the third element layer 23L. The third conductive layer 63 is fixed to the third element layer 23L. The third other conductive layer 63a is fixed to the third element layer 23L.

At least a part of the third other conductive layer 63a is located between the fixed electrode 63E and the third conductive layer 63. A third gap g3 is provided between the fixed electrode 63E and the third element layer 23L.

For example, a capacitance between the fixed electrode 63E and the third other conductive layer 63a changes depending on a state of a third detection target around the third element portion 10C. The third element portion 10C is, for example, a capacitance change type sensor.

At least a part of a first material of the first conductive layer 51 is the same as at least a part of a third material of the third conductive layer 63. The first conductive layer 51 may be formed from a material that will become the third conductive layer 63.

As shown in FIG. 5, the third element portion 10C may include a third element characteristic changing layer 33L. The third element characteristic changing layer 33L is fixed to the third element support portion 33s. For example, a volume of the third element characteristic changing layer 33L changes depending on the state of the third detection target. Thereby, the position of the third element layer 23L in the first direction D1 may be changed. This may change the capacitance. The third element characteristic changing layer 33L may include, for example, at least one selected from the group consisting of platinum, palladium, and titanium.

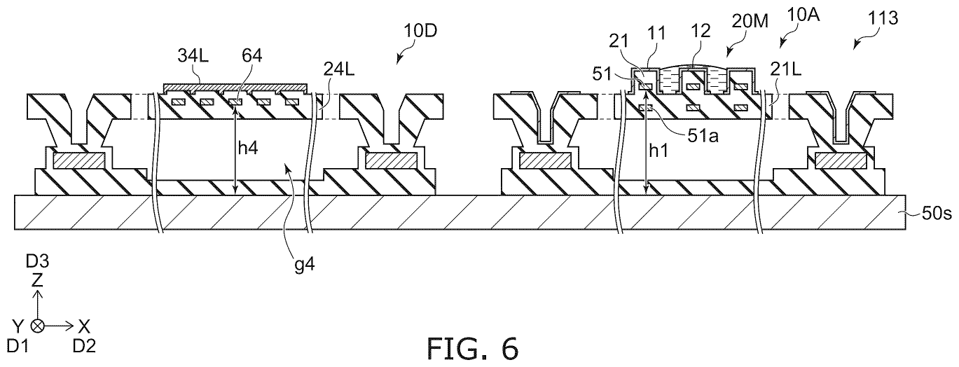

FIG. 6 is a schematic cross-sectional view illustrating a sensor according to the second embodiment.

As shown in FIG. 6, a sensor 113 according to the embodiment includes a fourth element portion 10D in addition to the first element portion 10A.

The fourth element portion 10D includes a fourth element layer 24L and a fourth conductive layer 64 fixed to the fourth element layer 24L. A fourth gap g4 is provided between the base 50s and the fourth element layer 24L. An electrical resistance of the fourth conductive layer 64 changes depending on a state of a fourth detection target around the fourth element portion 10D. The first conductive layer height h1 of the first conductive layer 51 with respect to the base 50s may be substantially the same as a fourth conductive layer height h4 of the fourth conductive layer 64 with respect to the base 50s. For example, the first conductive layer 51 may be formed from a material that will become the fourth conductive layer 64. The protruding portion (such as the first protruding portion 21) can be obtained by a simple process.

As shown in FIG. 6, the fourth element portion 10D may include a fourth element characteristic change layer 34L. The fourth conductive layer 64 is located between the base 50s and the fourth element characteristic change layer 34L. For example, the fourth element characteristic change layer 34L changes depending on a state of a fourth detection target. Thereby, the electrical resistance of the fourth conductive layer 64 can be changed. The fourth element portion 10D is, for example, a contact combustion type sensor. The fourth element characteristic change layer 34L may include, for example, at least one selected from the group consisting of palladium, platinum, silver, and rhodium.

Embodiments may include the following Technical proposals.

### Technical Proposal 1

A sensor, comprising
a first element portion,
the first element portion including
an element member,
a first electrode including a first side portion,
a second electrode including a second side portion, and
an oxide member including a first oxide portion,
the element member including
   a first element layer,
   a first protruding portion provided on the first element layer and protruding in a first direction, and
   a second protruding portion provided on the first element layer and protruding in the first direction,
a second direction from the first protruding portion to the second protruding portion crossing the first direction,
the first oxide portion being between the first protruding portion and the second protruding portion,
the first side portion being between the first protruding portion and the first oxide portion, and
the second side portion being between the first oxide portion and the second protruding portion.

### Technical Proposal 2

The sensor according to Technical proposal 1, wherein
the first protruding portion includes a first side face crossing the second direction,
the second protruding portion includes a second side face crossing the second direction,
the first side portion is provided on the first side face, and
the second side portion is provided on the second side face.

### Technical Proposal 3

The sensor according to Technical proposal 2, wherein
the first protruding portion further includes a first apex region,
the second protruding portion further includes a second apex region,
the first electrode further includes a first apex portion provided on the first apex region, and
the second electrode further includes a second apex portion provided on the second apex region.

### Technical Proposal 4

The sensor according to any one of Technical proposals 1-3, wherein
the first electrode further includes a first other side portion,
the second electrode further includes a second other side portion,
at least a part of the first protruding portion is between the first other side portion and the first side portion in the second direction, and
at least a part of the second protruding portion is between the second side portion and the second other side portion in the second direction.

### Technical Proposal 5

The sensor according to any one of Technical proposals 1-4, wherein
a first height of the first protruding portion is more than a first thickness of the first side portion along the second direction.

### Technical Proposal 6

The sensor according to Technical proposal 5, wherein
the first height is 5 times or more the first thickness.

### Technical Proposal 7

The sensor according to any one of Technical proposals 1-4, wherein
a length of the first side portion along the first direction of the first side portion is longer than a first thickness of the first side portion along the second direction.

### Technical Proposal 8

The sensor according to any one of Technical proposals 1-7, wherein
the first element layer includes a first non-overlapping region,
the first non-overlapping region does not overlap the first protruding portion in the first direction, and
a direction from a part of the first non-overlapping region to a part of the first electrode is along the first direction.

### Technical Proposal 9

The sensor according to any one of Technical proposals 1-8, wherein
the first electrode and the second electrode are configured such that an electrical resistance between the first electrode and the second electrode changes depending on a first detection target around the first element portion.

### Technical Proposal 10

The sensor according to any one of Technical proposals 1-9, wherein
the oxide member includes a plurality of first particles including an oxide,
the oxide includes oxygen and at least one selected from the group consisting of tin, zinc, tungsten, molybdenum, and indium, and
at least one of the first electrode or the second electrode includes at least one selected from the group consisting of platinum, gold, silver, copper, palladium, aluminum, and titanium nitride.

### Technical Proposal 11

The sensor according to any one of Technical proposals 1 to 10, wherein
the first electrode extends along a third direction crossing a plane the first direction and the second direction, and
the second electrode extends along the third direction.

### Technical Proposal 12

The sensor according to any one of Technical proposals 1-11, wherein
the first element portion includes a plurality of the first electrodes and a plurality of the second electrodes,
one of the plurality of the first electrodes is between one of the plurality of the second electrodes and another one of the plurality of the second electrodes,
the one of the plurality of the second electrodes is between the one of the plurality of the first electrodes and another one of the plurality of the first electrodes,
the first protruding portion is provided corresponding to each of the plurality of the first electrodes, and
the second protruding portion is provided corresponding to each of the plurality of the second electrodes.

### Technical Proposal 13

The sensor according to any one of Technical proposals 1-12, wherein
the element member further includes a first conductive layer, and
at least a part of the first conductive layer is between a part of the first protruding portion and another part of the first protruding portion in the second direction.

### Technical Proposal 14

The sensor according to Technical proposal 13, wherein
the first conductive layer is embedded in the first protruding portion.

### Technical Proposal 15

The sensor according to Technical proposal 13 or 14, wherein
the element member further includes a first other conductive layer, and
at least a part of the first other conductive layer overlaps the first conductive layer in the first direction.

### Technical Proposal 16

The sensor according to any one of Technical proposals 13-15, further comprising:
a first circuit configured to supply power to the first conductive layer.

### Technical Proposal 17

The sensor according to any one of Technical proposals 13-16, further comprising:
a base,
the first element portion further including a first fixed portion fixed to the base,
the first element layer being supported by the first fixed portion, and
a first gap being provided between the base and the first element layer.

### Technical Proposal 18

The sensor according to Technical proposal 17, further comprising:
a second element portion,
the second element portion including:
   a second element layer, and
      a second conductive layer fixed to the second element layer,
a second gap being provided between the base and the second element layer, t [symbol]
an electrical resistance of the second conductive layer being configures to change according to a flow velocity of a second detection target around the second element portion, and
a first conductive layer height of the first conductive layer with respect to the base being substantially the same as a second conductive layer height of the second conductive layer with respect to the base.

### Technical Proposal 19

The sensor according to Technical proposal 17, further comprising:
a third element portion,
the third element portion including
   a fixed electrode fixed to the base,
   a third element layer,
   a third element support portion fixed to the base and supporting the third element layer,
   a third conductive layer fixed to the third element layer, and
   a third other conductive layer fixed to the third element layer,
at least a part of the third other conductive layer being between the fixed electrode and the third conductive layer,
a third gap being provided between the fixed electrode and the third element layer,
a capacitance between the fixed electrode and the third other conductive layer being configures to change depending on a state of a third detection target around the third element portion, and
at least a part of a first material of the first conductive layer is the same as at least a part of a third material of the third conductive layer.

### Technical Proposal 20

The sensor as according to Technical proposal 17, further comprising:
a fourth element portion,
the fourth element portion including
   a fourth element layer, and
   a fourth conductive layer fixed to the fourth element layer,
a fourth gap being provided between the base and the fourth element layer,
an electrical resistance of the fourth conductive layer being configured to change depending on a state of a fourth detection target around the fourth element portion, and
a first conductive layer height of the first conductive layer with respect to the base being substantially the same as a fourth conductive layer height of the fourth conductive layer with respect to the base.

According to an embodiment, a sensor is provided that allows for improved characteristics.

In the specification, “electrically connected” includes a state in which plurality of conductors are physically in contact with each other and current flows between these plurality of conductors. “Electrically connected” includes a state in which a conductor is inserted between plurality of conductors and current flows between these plurality of conductors.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as element members, element layers, electrodes, oxide members, fixed portions, connecting portions, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising
a first element portion,
the first element portion including
an element member,
a first electrode including a first side portion,
a second electrode including a second side portion, and
an oxide member including a first oxide portion,
the element member including
a first element layer,
a first protruding portion provided on the first element layer and protruding in a first direction, and
a second protruding portion provided on the first element layer and protruding in the first direction,
a second direction from the first protruding portion to the second protruding portion crossing the first direction,
the first oxide portion being between the first protruding portion and the second protruding portion,
the first side portion being between the first protruding portion and the first oxide portion, and
the second side portion being between the first oxide portion and the second protruding portion.

2. The sensor according to claim 1, wherein
the first protruding portion includes a first side face crossing the second direction,
the second protruding portion includes a second side face crossing the second direction,
the first side portion is provided on the first side face, and
the second side portion is provided on the second side face.

3. The sensor according to claim 2, wherein
the first protruding portion further includes a first apex region,
the second protruding portion further includes a second apex region,
the first electrode further includes a first apex portion provided on the first apex region, and
the second electrode further includes a second apex portion provided on the second apex region.

4. The sensor according to claim 1, wherein
the first electrode further includes a first other side portion,
the second electrode further includes a second other side portion,
at least a part of the first protruding portion is between the first other side portion and the first side portion in the second direction, and
at least a part of the second protruding portion is between the second side portion and the second other side portion in the second direction.

5. The sensor according to claim 1, wherein
a first height of the first protruding portion is more than a first thickness of the first side portion along the second direction.

6. The sensor according to claim 5, wherein
the first height is 5 times or more the first thickness.

7. The sensor according to claim 1, wherein
a length of the first side portion along the first direction of the first side portion is longer than a first thickness of the first side portion along the second direction.

8. The sensor according to claim 1, wherein
the first element layer includes a first non-overlapping region,
the first non-overlapping region does not overlap the first protruding portion in the first direction, and
a direction from a part of the first non-overlapping region to a part of the first electrode is along the first direction.

9. The sensor according to claim 1, wherein
the first electrode and the second electrode are configured such that an electrical resistance between the first electrode and the second electrode changes depending on a first detection target around the first element portion.

10. The sensor according to claim 1, wherein
the oxide member includes a plurality of first particles including an oxide,
the oxide includes oxygen and at least one selected from the group consisting of tin, zinc, tungsten, molybdenum, and indium, and
at least one of the first electrode or the second electrode includes at least one selected from the group consisting of platinum, gold, silver, copper, palladium, aluminum, and titanium nitride.

11. The sensor according to claim 1, wherein
the first electrode extends along a third direction crossing a plane the first direction and the second direction, and
the second electrode extends along the third direction.

12. The sensor according to claim 1, wherein
the first element portion includes a plurality of the first electrodes and a plurality of the second electrodes,
one of the plurality of the first electrodes is between one of the plurality of the second electrodes and another one of the plurality of the second electrodes,
the one of the plurality of the second electrodes is between the one of the plurality of the first electrodes and another one of the plurality of the first electrodes,
the first protruding portion is provided corresponding to each of the plurality of the first electrodes, and
the second protruding portion is provided corresponding to each of the plurality of the second electrodes.

13. The sensor according to claim 1, wherein
the element member further includes a first conductive layer, and
at least a part of the first conductive layer is between a part of the first protruding portion and another part of the first protruding portion in the second direction.

14. The sensor according to claim 13, wherein
the first conductive layer is embedded in the first protruding portion.

15. The sensor according to claim 13, wherein
the element member further includes a first other conductive layer, and
at least a part of the first other conductive layer overlaps the first conductive layer in the first direction.

16. The sensor according to claim 13, further comprising:
a first circuit configured to supply power to the first conductive layer.

17. The sensor according to claim 13, further comprising:
a base,
the first element portion further including a first fixed portion fixed to the base,
the first element layer being supported by the first fixed portion, and
a first gap being provided between the base and the first element layer.

18. The sensor according to claim 17, further comprising:
a second element portion,
the second element portion including:
a second element layer, and
a second conductive layer fixed to the second element layer,
a second gap being provided between the base and the second element layer, t [symbol]
an electrical resistance of the second conductive layer being configures to change according to a flow velocity of a second detection target around the second element portion, and
a first conductive layer height of the first conductive layer with respect to the base being substantially the same as a second conductive layer height of the second conductive layer with respect to the base.

19. The sensor according to claim 17, further comprising:
a third element portion,
the third element portion including
a fixed electrode fixed to the base,
a third element layer,
a third element support portion fixed to the base and supporting the third element layer,
a third conductive layer fixed to the third element layer, and
a third other conductive layer fixed to the third element layer,
at least a part of the third other conductive layer being between the fixed electrode and the third conductive layer,
a third gap being provided between the fixed electrode and the third element layer,
a capacitance between the fixed electrode and the third other conductive layer being configures to change depending on a state of a third detection target around the third element portion, and
at least a part of a first material of the first conductive layer is the same as at least a part of a third material of the third conductive layer.

20. The sensor according to claim 17, further comprising:
a fourth element portion,
the fourth element portion including
a fourth element layer, and
a fourth conductive layer fixed to the fourth element layer,
a fourth gap being provided between the base and the fourth element layer,
an electrical resistance of the fourth conductive layer being configured to change depending on a state of a fourth detection target around the fourth element portion, and
a first conductive layer height of the first conductive layer with respect to the base being substantially the same as a fourth conductive layer height of the fourth conductive layer with respect to the base.
